(19) United States
(12) Patent Application Publication
(10) Pub. No.: US 2008/0025774 A1
(43) Pub. Date: Jan. 31, 2008

(54) IMAGE FORMING METHOD AND APPARATUS

(76) Inventors: Mikio ISHIBASHI, Yokohama-shi (JP); Kazuhisa SUDO, Kawasaki-shi (JP); Yukiko IWASAKI, Yokohama-shi (JP); Megumi OHTOSHI, Kawasaki-shi (JP); Reki NAKAMURA, Sagamihara-shi (JP); Masafumi YAMADA, Kawasaki-shi (JP); Toshihiro SUGIYAMA, Shinagawa-ku (JP); Nobuyuki KOINUMA, Yokohama-shi (JP); Takashi SAKAMAKI, Ebina-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/831,461

(22) Filed: Jul. 31, 2007

(30) Foreign Application Priority Data
Jul. 31, 2006 (JP) 2006-209284
Jun. 12, 2007 (JP) 2007-155736

(51) Int. Cl. G03G 15/00

(52) U.S. Cl. 399/341

(57) ABSTRACT

An image forming method includes steps of electrophotographic image formation and liquid material application. The electrophotographic image forming step electrophotographically forms an image on a recording medium having at least one transparent portion. The transparent portion has a surface to receive the image thereon. The applying step applies a coating of an opaque liquid material onto the surface of the transparent portion of the recording medium.

### CROSS REFERENCE TO RELATED APPLICATIONS

The present patent application claims priority from Japanese Patent Application Nos. 2006-209284, filed on Jul. 31, 2006, and 2007-155736, filed on Jun. 12, 2007 in the Japanese Patent Office, the entire disclosure of each of which is hereby incorporated by reference herein in its entirety.

### BACKGROUND OF THE INVENTION

1. Field of the Invention

The present invention relates to an image forming method and apparatus, and more particularly, to an image forming method and apparatus capable of readily forming an image with a photographic appearance.

2. Discussion of the Background

Several attempts have been made in the development of electrophotographic image forming apparatuses and/or methods to achieve a high-gloss, photo-like image with a simple mechanism.

For example, a conventional image forming apparatus performing a conventional image forming method uses specific toner particles to give a gloss to a formed image. These specific toner particles include no coloring material, and are uniformly applied to a recording medium on which a toner image is formed by a known electrographic process. The image is then fixed in a fixing unit to create a photo-like image.

One drawback of such a method is difficulty in uniformly and constantly applying the specific toner particles to the image surface. Moreover, since a layer of toner is formed with variations in thickness, processing the layer of toner may put a heavy load on the fixing unit.

Another conventional image forming method makes use of a specific recording medium, which is intended for use with a specific image forming apparatus. For example, the specific recording medium has a thermoplastic resin layer on at least one surface thereof, and the specific image forming apparatus performs first and second fixing processes. The first fixing process is performed by a known fixing technique to fix a toner image onto the specific recording medium. The specific recording medium is further subjected to the second fixing process, in which the fixed image is processed with heat and pressure, then cooled to obtain a uniform gloss thereon. In particular, the second fixing process uses a belt member with a substantially smooth surface effective in reducing irregularities on the image surface.

In spite of the advantage of giving a uniform gloss to the image surface, such a method has several shortcomings in terms of cost, structural, and power consumption, due to the need to provide an additional fixing unit for the second fixing process.

Another issue regarding the development of electrophotographic image forming apparatuses and/or methods relates to image storage stability.

As one approach to improving image stability, a conventional image forming method makes use of a transparent film having an adhesive coating. The adhesive coating serves to bond the transparent film onto an image, protecting the image surface against damage. However, using such a method does not ensure the quality of the image as the appearance of the image may be affected by the transparent film bonded thereto by the medium of the adhesive coating.

In another conventional method, a transparent film is also used in processing a retroreflective sheet material. Retroreflective sheets are commonly used to display images, but in general, printing on the retroreflective sheet material is difficult. In this method, an image is formed on a transparent film, which is then bonded to a retroreflective sheet so that the image appears on a surface of the retroreflective sheet.

Such a method is designed to overcome the difficulty in printing an image on the retroreflective sheet material. However, using this method, as well as the above-described adhesive coating method, does not provide a solution to obtaining an electrophotographic image with a photographic appearance and good storage stability.

### SUMMARY OF THE INVENTION

This patent specification describes a novel image forming method capable of readily forming an image with a photographic appearance.

In one embodiment, the novel image forming method includes the steps of electrophotographical image formation and liquid material application. The electrophotographically forming step electrophotographically forms an image on a recording medium having at least one transparent portion. The transparent portion has a surface to receive the image thereon. The applying step applies a coating of an opaque liquid material onto the surface of the transparent portion of the recording medium.

This patent specification further describes a novel image forming apparatus capable of readily forming an image with a photographic appearance.

In one embodiment, the novel image forming apparatus includes an electrophotographic mechanism and a coating mechanism. The electrophotographic mechanism is configured to electrophotographically form an image on a recording medium having at least one transparent portion. The transparent portion has a surface to receive the image thereon. The coating mechanism is configured to apply a coating of an opaque liquid material onto the surface of the transparent portion. The coating mechanism has a plurality of nozzles arranged in a line.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic illustration of an image forming apparatus according to at least one exemplary embodiment of the present invention;

FIG. 2A is a schematic illustration of an example of a recording medium for use with the image forming apparatus of FIG. 1;

FIG. 2B is a schematic illustration of another example of the recording medium for use with the image forming apparatus of FIG. 1;

FIG. 2C is a schematic illustration of another example of the recording medium for use with the image forming apparatus of FIG. 1;

FIG. 2D is a schematic illustration of another example of the recording medium for use with the image forming apparatus of FIG. 1; and

FIG. 3 is a schematic illustration representing examples of a coater included in the image forming apparatus of FIG. 1.

### DETAILED DESCRIPTION OF THE PREFERRED EMBODIMENTS

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner.

Referring now to the drawings, wherein like reference numerals designate identical or corresponding parts throughout the several views, exemplary embodiments of the present patent application are described.

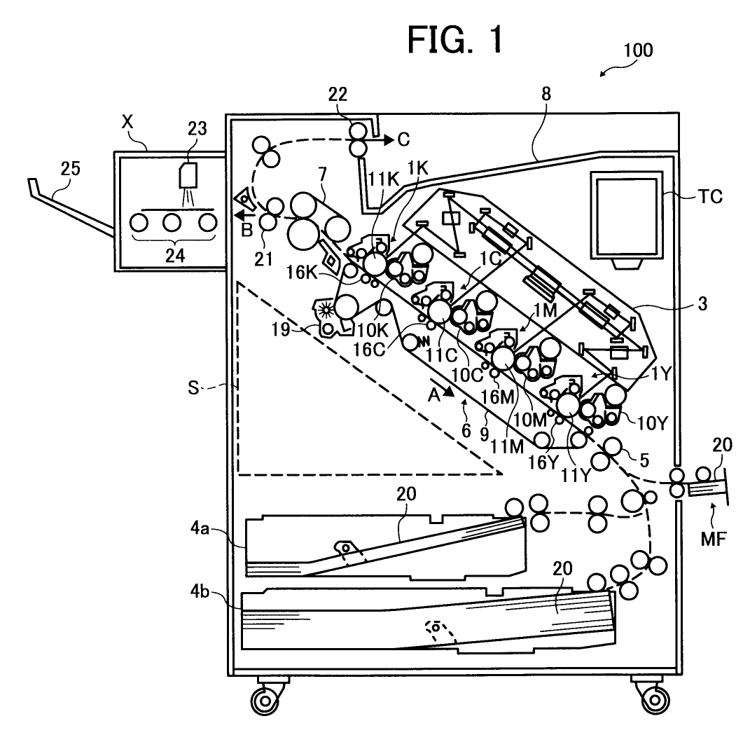

Referring to FIG. 1 of the drawings, an image forming apparatus 100 according to at least one exemplary embodiment of the present invention is described.

The image forming apparatus 100 includes four image forming units 1Y, 1M, 1C, and 1K, a scanning unit 3, a transfer unit 6, and a coating unit X.

The image forming units 1Y, 1M, 1C, and 1K each includes a development device 10Y, 10M, 10C, and 10K, respectively, and a photoconductive drum 11Y, 11M, 11C, and 11K, respectively. Each of the image forming unit 1Y, 1M, 1C, and 1K also includes a charge roller, not shown, and a cleaning device, not shown.

Each of the development devices 10Y, 10M, 10C, and 10K includes a two-component developer, not shown, a development roller, not shown, a screw, not shown, and a density sensor, not shown. The development roller has a rotatable sleeve outside and a magnet fixed inside.

The scanning unit 3 includes a light source such as a laser diode, not shown, a polygon mirror, not shown, an f-theta lens, not shown, and a reflecting mirror, not shown.

The transfer unit 6 includes a drive mechanism, not shown, a transfer belt 9, and transfer rollers 16Y, 16M, 16C, and 16K.

The coating unit X includes a coater 23, transport rollers 24, a second output tray 25, and a controller, not shown.

Further, the image forming apparatus 100 includes a pair of registration rollers 5, a cleaning unit 19, a fixing unit 7, a first output tray 8, first and second pairs of ejection rollers 21 and 22, first and second sheet cassettes 4a and 4b, a manual feeder MF, a recording medium 20, and a toner container TC.

Furthermore, the image forming apparatus 100 includes a waste toner bottle, not shown, a duplex/inverting path, not shown, a power supply, not shown, etc., which are disposed in a space S indicated by a dotted line in FIG. 1.

The image forming apparatus 100 uses toner of four colors, yellow (Y), magenta (M), cyan (C), and black (B). The toner colors are respectively associated with the image forming units 1Y, 1M, 1C, and 1K, so that the yellow toner is contained in the development device 10Y, the magenta toner in the development device 10M, the cyan toner in the development device 10C, and the black toner in the development device 10K.

The toner is combined with a magnetic carrier to form the two-component developer. Alternatively, a one-component developer may be used with a suitable configuration.

In the image forming apparatus 100, the image forming units 1Y, 1M, 1C, and 1K are aligned in a row along the transfer belt 9 at given intervals so that the photoconductive drums 11Y, 11M, 11C, and 11K have rotation axes parallel to each other. The development devices 10Y, 10M, 10C, and 10K are located so that each development roller is in contact with each of the photoconductive drums 11Y, 11M, 11C, and 11K.

The scanning unit 3 is disposed above the row of the image forming units 1Y, 1M, 1C, and 1K. The transfer unit 6 is disposed below the row of the image forming units 1Y, 1M, 1C, and 1K.

Each of the transfer rollers 16Y, 16M, 16C, and 16K is disposed on an opposite side of the transfer belt 9 from each of the photoconductive drums 11Y, 11M, 11C, and 11K.

The cleaning unit 19 is located in contact with an outside surface of the transfer belt 9. The cleaning unit 19 has a brush roller, not shown, and a cleaning blade, not shown, to remove residual toner or foreign matter carried on the transfer belt 9.

The fixing unit 7, the first output tray 8, and the first and second pairs of ejection rollers 21 and 22 are disposed adjacent to the transfer unit 6.

The first and second sheet cassettes 4a and 4b are located in a lower portion of the image forming apparatus 100, storing the recording medium 20 in a stack thereon. The manual feeder MF is provided at a side of the image forming apparatus 100, and is used to manually feed the recording medium 20.

The image forming apparatus 100 may be implemented by, for example, a color laser printer IPSiO CX9000 manufactured by Ricoh Co., Ltd.

The recording medium 20 may be a sheet material of given length and width that can be handled by a common image forming apparatus. An image is formed with a width in accordance with the width of the recording medium 20.

In the image forming apparatus 100, a color image is formed by superimposition of images of four colors, which are respectively formed by the image forming units 1Y, 1M, 1C, and 1K.

In each of the image forming units 1Y, 1M, 1C, and 1K, the charge roller is activated with a voltage from the power supply to charge each surface of the photoconductive drums 11Y, 11M, 11C, and 11K to a given potential. The scanning unit 3 scans each surface of the photoconductive drums 11Y, 11M, 11C, and 11K with a laser beam to form an electrostatic latent image using the polygon mirror, the f-theta lens, and the reflecting mirror in accordance with image data. Alternatively, the scanning operation may be performed using a light emitting diode (LED) array.

In each of the development devices 10Y, 10M, 10C, and 10K, the screw agitates the two-component developer contained therein. The toner density sensor provides an output indicating toner density of the two-component developer so that an adequate amount of toner can be supplied from the toner container TC corresponding to the output.

Each of the photoconductive drums 11Y, 11M, 11C, and 11K rotates to carry the electrostatic latent image to a position opposite to and facing the development roller. Then, toner particles supplied from the development roller adhere to the electrostatic latent image to form a toner image on each of the photoconductive drums 11Y, 11M, 11C, and 11K.

The recording medium 20 is fed from any one of the first and second sheet cassettes 4a and 4b and the manual feeder MF to be engaged between the pair of registration rollers 5. The pair of registration rollers 5 conveys the recording medium 20 so as to sequentially transfer, in registration, the toner images onto the recording medium 20.

In transferring the toner images onto the recording medium 20, the drive mechanism rotates the transfer belt 9 in a direction indicated by arrow A to convey the recording medium 20 through a nip between each transfer roller and associated photoconductive drum. The transfer rollers 16Y, 16M, 16C, and 16K each applies a voltage generated from the power supply, opposite in polarity to the toner particles, to attract the toner images onto the recording medium from the photoconductive drums 11Y, 11M, 11C, and 11K, respectively. The toner images of four colors are thereby superimposed to obtain a color image.

The recording medium 20 on which the color image is formed then reaches the fixing unit 7. In the fixing unit 7, the color image is fixed on the recording medium 20 by applying heat and pressure. The fixing process may be performed using a belt-shaped or roller-shaped fixing device, or by using an induction heater.

In a normal mode operation, the recording medium 20 on which a color image is fixed by the fixing unit 7 is transported by the first and second pairs of ejection rollers 21 and 22 in a direction designated by arrow C to the first output tray 8.

In a high-gloss mode operation, the recording medium 20 on which a color image is fixed by the fixing unit 7 is transported in a direction designated by arrow B to the coating unit X.

In the coating unit X, the coater 23 applies a liquid coating on a surface of the recording medium 20. The recording medium 20 is transported by the transport rollers 24 to the second output tray 25. The operation of the coating unit X is controlled by the controller.

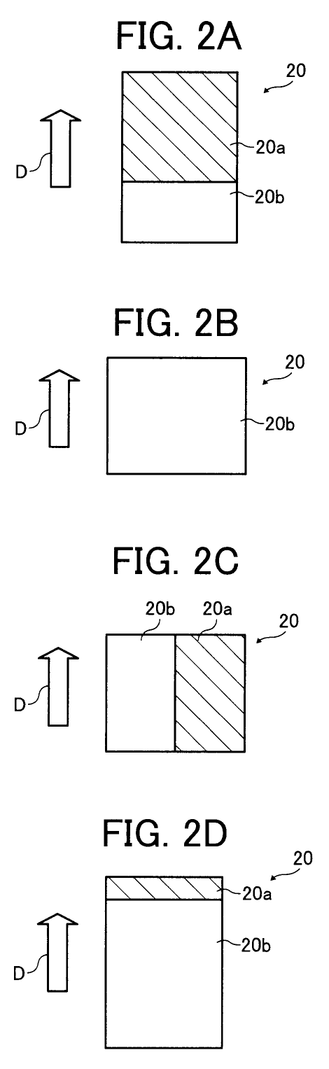

Referring now to FIGS. 2A through 2D, examples of the recording medium 20 for use with the high-gloss mode operation are described.

In FIGS. 2A through 2D, an arrow “D” designates a direction in which the recording medium 20 is fed within the image forming apparatus 100 (hereinafter referred to as “feed direction”). The feed direction is vertically upward in FIGS. 2A through 2D.

The recording medium 20 includes an opaque portion 20a and at least one transparent portion 20b.

For example, as shown in FIG. 2A, the opaque portion 20a may comprise more than half the area of the recording medium 20, with the transparent portion 20b comprising a part other than the opaque portion 20a. The recording medium 20 is to be fed with the opaque portion 20a directed forward in the feed direction.

Further, as shown in FIG. 2B, the transparent portion 20b may form the entire portion of the recording medium 20.

Furthermore, as shown in FIG. 2C, the transparent portion 20b and the opaque portion 20a each forms half of the recording medium 20. The recording medium 20 is fed in the feed direction with the opaque portion 20a on one side and the transparent portion 20b on another side.

Moreover, as shown in FIG. 2D, the opaque portion 20a may form a small part of the recording medium 20, with the transparent portion 20b forming a part other than the opaque portion 20a. The recording medium 20 is fed with the opaque portion 20a directed forward in the feed direction.

In the recording medium 20, the opaque portion 20a is formed of any sheet material commonly used as copy paper. The transparent portion 20b is formed of transparent sheet material with a smooth surface onto which an image is formed, such as an OHP film TYPE PPC-E manufactured by NBS Ricoh Co., Ltd., OHP films PP2500 and PP2600 manufactured by Sumitomo 3M Limited, or a transparency film for use with a color laser printer manufactured by folex AG.

The opaque portion 20a may be used like a blank frame of an instant photo, on which a user can write words or draw pictures. Further, by performing printing on the opaque portion 20a, a printed material containing text and pictures, which may be used as an illustrated calendar, can be easily created.

In performing the high-gloss mode operation, an area of the transparent portion 20b in the recording medium 20 may be determined by user-adjusted feed-process settings, or by prior registration in the image forming apparatus 100.

When it is determined that an image is to be created on the transparent portion 20b, the image forming apparatus 100 creates a reverse image of an original on the smooth surface (hereinafter referred to as “print surface”) by the image forming process as described with reference to FIG. 1. As a result, the reverse image is to be viewed from a surface opposite to the print surface (hereinafter referred to as “non-print surface”) so that a viewer can see a non-reverse image represented thereon. The image thus created has a substantially smooth surface and firmly adheres to the recording medium 20.

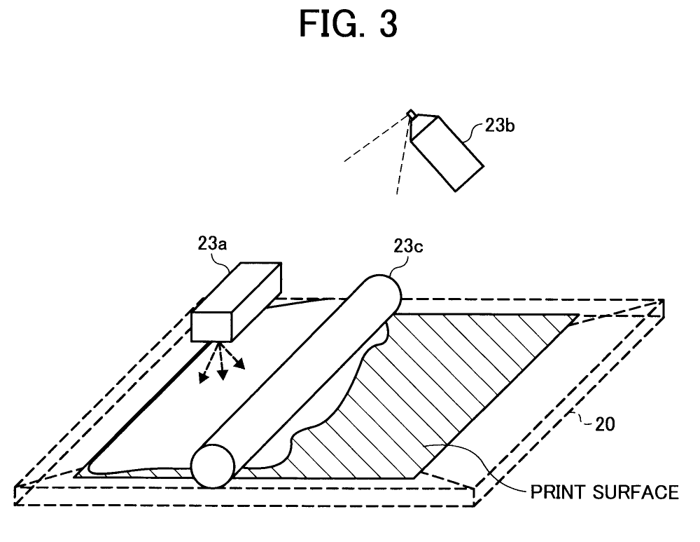

Referring now to FIG. 3, a schematic illustration representing examples of the coater 23 according to the present specification is described.

The coating may be performed using any device or process commonly used to coat a sheet material, such as a linear array type coater (23a in FIG. 3), a spray type coater (23b in FIG. 3), a roller type coater (23c in FIG. 3), a sponge type coater, an offset printing process, a screen printing process, or an intaglio printing process.

Preferably, the coater 23 may be the linear array type coater 23a. The linear array type coater 23a includes a plurality of nozzles arranged in a line, from which the opaque liquid coating is discharged. The linear array type coater 23a can perform coating on sheet materials of different widths by varying the number of nozzles to be enabled during discharge.

In the coating unit X, the controller acquires data indicating the width of the transparent portion and directs the coater 23 to selectively perform coating on the recording medium 20 so as to avoid applying the opaque liquid coating to an area that does not need to be coated. The opaque liquid coating applied to the recording medium 20 is fixed by a suitable process such as cold or heated air drying and ultraviolet curing.

The opaque liquid coating serves to protect the print surface from damage. The color of the opaque liquid coating may be preferably white.

The opaque liquid coating may be of any material suitable for use in coating on the recording medium 20, such as ink and paint commonly used. Examples of the opaque liquid coating include a non-VOC paint HARMONY® manufactured by Sherwin-Williams Company, an elastic filler MAX manufactured by DAI NIPPON TORYO CO., LTD., a paint LAQUER manufactured by Kanpe Hapio Co., Ltd., a paint HIT-SPRAY manufactured by Kanpe Hapio Co., Ltd., a thermoset, one-component aqueous polyurethane paint manufactured by Nippon Paint Co., Ltd., and an elastic high-gloss aqueous paint manufactured by Nippon Paint Co., Ltd.

By forming the reverse image on the smooth surface of the transparent portion 20b, a photographic appearance can be easily provided to the non-reverse image. The photographic appearance may be enhanced with gloss by forming the transparent portion 20b with smoothness on the non-print surface.

Numerous additional modifications and variations are possible in light of the above teachings. It is therefore to be understood that within the scope of the appended claims the disclosure of this patent specification may be practiced otherwise than as specifically described herein.

What is claimed is:

1. An image forming method, comprising:
electrophotographically forming an image on a recording medium having at least one transparent portion, the transparent portion having a surface to receive the image thereon; and
applying a coating of an opaque liquid material onto the surface of the transparent portion.

2. The image forming method according to claim 1, wherein the surface of the transparent portion is smooth.

3. The image forming method according to claim 1, wherein the opaque liquid material is white in color.

4. The image forming method according to claim 1, wherein the image is formed as a reverse copy of an original.

5. An image forming apparatus, comprising:
an electrophotographic mechanism configured to electrophotographically form an image on a recording medium having at least one transparent portion, the transparent portion having a surface to receive the image thereon; and
a coating mechanism configured to apply a coating of an opaque liquid material onto the surface of the transparent portion, the coating mechanism having a plurality of nozzles arranged in a line.

6. The image forming apparatus according to claim 5, wherein the surface of the transparent portion is smooth.

7. The image forming apparatus according to claim 5, wherein the opaque liquid material is white in color.

8. The image forming apparatus according to claim 5, wherein the image is formed as a reverse copy of an original.

9. The image forming apparatus according to claim 5, wherein the coating mechanism applies the coating to an area of a given width in accordance with a size of the transparent portion.
